(19) United States
(12) Patent Application Publication
(10) Pub. No.: US 2025/0233315 A1
(43) Pub. Date: Jul. 17, 2025

(54) ANTENNA SYSTEM FOR WIDE ANGLE SCANNING ANTENNA ARRAY

(71) Applicant: The Antenna Company International N.V., Eindhoven (NL)

(72) Inventors: Yingqi ZHANG, Gothenburg (SE); Stanislav OGURTSOV, Eindhoven (NL); Vasilii VASILEV, Veldhoven (NL); Diego CARATELLI, Eersel (NL)

(21) Appl. No.: 19/016,099

(22) Filed: Jan. 10, 2025

Related U.S. Application Data
(60) Provisional application No. 63/620,019, filed on Jan. 11, 2024.

(51) Int. Cl. H01Q 13/18; H01Q 1/22

(52) U.S. Cl. CPC H01Q 13/18; H01Q 1/2283

(57) ABSTRACT

The invention relates to an antenna element comprising a dielectric substrate and a multi-layer laminate structure included in the dielectric substrate. The multi-layer laminate structure comprises an impedance matching layer, a resonating cavity with a cross-shaped slot, and a pair conductive forks, configured and arranged to feed the cross-shaped slot. The invention further relates to an antenna subarray, comprising a dielectric substrate and a multi-layer laminate structure included in the dielectric substrate. The multi-layer laminate structure comprises an impedance matching layer, an array of resonating cavities, each with a cross-shaped slot, and an array of pairs of conductive forks, each pair configured and arranged to feed the cross-shaped slot of a corresponding resonating cavity.

The present invention relates to an antenna system for wide-angle scanning. The invention relates to a metasurface-loaded antenna element designed for planar arrays using low temperature co-fired ceramic technology (LTCC), which is easy to mount. The invention also relates to operating an antenna system for wide-angle scanning.

The demand for enhanced data rates and expanded radio coverage in 5G communications has driven the development of integrated phased antenna array solutions with substantial gain and wide beamsteering capabilities. Millimeter-wave phased array configurations, such as Antenna-on-Chip and Antenna-in-Module systems, achieve integration by embedding antennas on the chip or co-designing them with active integrated circuits. However, on-chip antennas suffer from diminished radiation efficiency due to material loss concerns, and joint antenna-circuit designs necessitate complex system-level multiphysics analysis.

Another prevalent approach is Antenna-in-Package, where antennas and circuit modules are stacked vertically or laterally in a single assembly via transitions. This method allows for the integration of antennas, integrated circuits, and digital/radio frequency controls at the front-end, enabling scalable module-level array beamforming. Suitable technologies for implementing such antenna designs encompass printed circuit boards, low-temperature co-fired ceramics, etc., where multiple conductive layers and vias are allowed for more degree of design freedom.

In phased array scenarios, traditional printed antennas suffer from surface waves, mutual coupling between elements, poor cross-polarization suppression that deteriorate operating bandwidth and wide-angle scanning performances. Methods to improve the performances might include complicated structural adaptations and engage multi-step manufacturing processes and assembly of the array.

There is a need to design compact structural array antennas in simple, cost-effective manufacturing processes eligible for wide-angle scanning at millimeter waves. In addition, such arrays should be easily mountable on RF systems as a surface mount device (SMD).

It is the first objective of the invention to provide an improved antenna system for wide angle scanning. It is a second objective of the invention to provide a multilayered structure that enhances the antennas beamwidth and scanning angles. It is a third objective of the invention to enable polarization control. It is a fourth objective of this invention to combine subarrays into large array configurations for integration with Radio frequency integrated units. It is a fifth objective of this invention to resolve heat dissipation and routing issues often encountered in larger arrays. It is a sixth object of this invention to provide for easy to mount (SMD) antenna arrays for assembly.

This invention features an antenna element exhibiting a multilayered structure, including conductive vias, and is fabricated utilizing low temperature co-fired ceramic technology (LTCC). The antenna element is primarily composed of a dielectric substrate, which features a multi-layer laminate structure comprising a total of 15 conductive (metallized) layers.

A preferred embodiment of this invention is an antenna featuring a multilayered structure with 15 conductive layers, and operates at 28 GHz with a side length of 0.472.

The vertical separation between these layers is fixed at 0.1 mm. The side length of the antenna element measures 0.47 times the wavelength (λ) of free space, operating at a frequency of 28 GHz. The element is shown in FIG. 1. The top two conductive layers form a metasurface acting as an impedance matching layer, enhancing the antenna's bandwidth and scanning angles. Below, seven conductive layers and vias create a cylindrical dielectric resonating cavity with a cross-shaped slot for excitation. Beneath the ground plane, two orthogonal conductive forks feed the slot, enabling polarization control. The LTCC antenna is integrated into a printed circuit board (PCB) with ball grid arrays (BGAs) for electrical connections. For large array configurations, 2×2 subarrays of antenna elements are duplicated on PCBs, known as subarray modules, as shown in FIG. 6, 7A-7C. These modules allow for efficient integration of radio frequency integrated circuits (RFICs) and resolve heat dissipation and routing issues often encountered in larger arrays. An example of a 4*4 array is shown in FIG. 8).

### BRIEF DESCRIPTION OF THE FIGURES

FIG. 1 shows a transparent vertical cross-section of an embodiment of an antenna element according to the invention, as well as a printed circuit board, PCB, as may be part of an embodiment of an antenna system according to the invention;

FIG. 2A, 2B show, in different perspectives, an impedance matching layer as may be part of an embodiment of an antenna element according to the invention;

FIG. 3A, 3B show, in different perspectives, a resonating cavity with a cross-shaped slot as may be part of an embodiment of an antenna element according to the invention;

FIG. 4A, 4B show, in different perspectives, a pair of conductive forks as may be part of an embodiment of an antenna element according to the invention;

FIG. 5A, 5B show, in different perspectives, a lower ground layer as may be included in an embodiment of antenna element according to the invention, as well as a printed circuit board, PCB, as may be part of an embodiment of an antenna system according to the invention;

FIG. 6 shows a transparent vertical cross-section of an embodiment of an antenna subarray according to the invention, as well as a printed circuit board, PCB, as may be part of an embodiment of an antenna system according to the invention;

FIG. 7A-C show horizontal cross-sections of an embodiment of an antenna subarray according to the invention;

FIG. 8 shows, in an isometric perspective, an embodiment of an antenna system according to the invention including embodiments of antenna subarrays according to the invention;

FIG. 9-10 are graphs presenting the achieved active reflection coefficients when scanning in H-/V-plane for V-polarization ports at different scanning angles;

FIG. 11-12 are graphs presenting the achieved active reflection coefficients when scanning in H-/V-plane for H-polarization ports at different scanning angles;

FIG. 13-14 are graphs presenting the beam-steered radiation patterns and scanning performances for the H-polarization along the H-/V-planes for H-polarization at 27.5 GHz;

FIG. 15-16 are graphs presenting the beam-steered radiation patterns and scanning performances for the H-polarization along the H-/V-planes for H-polarization at 28.35 GHz.

### DETAILED DESCRIPTION

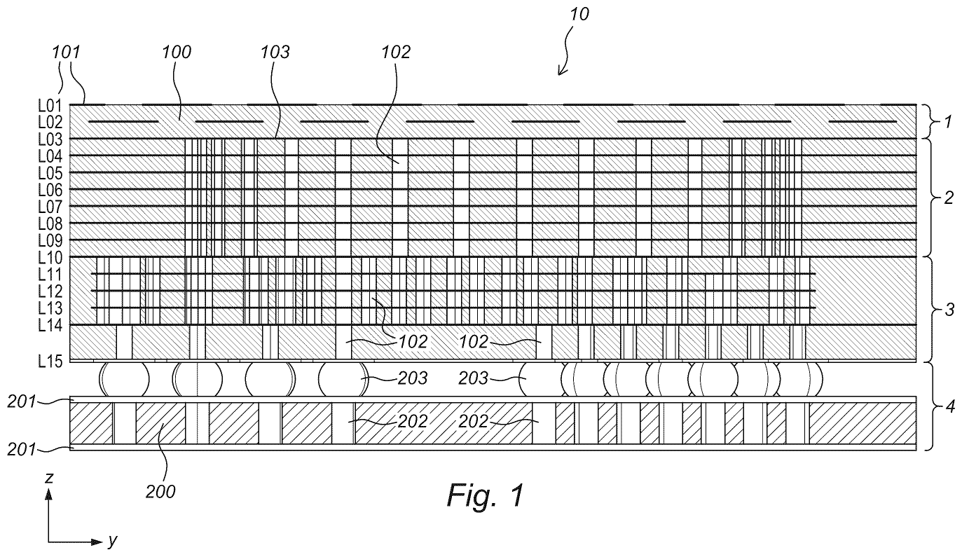

FIG. 1 shows an antenna element 10 including a dielectric substrate 100, which features a multi-layer laminate structure 1, 2, 3 comprising a total of 15 conductive (metallized) layers.

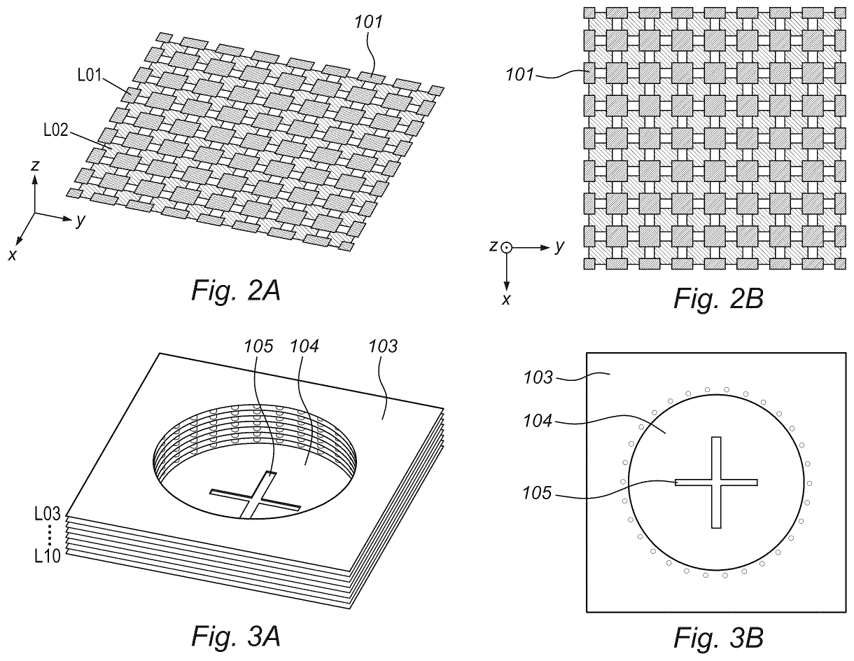

On top of the antenna are two conductive layers, referred to as L01 and L02 (FIG. 1) which serve as metasurface layers, specifically designed for integration into a planar antenna array. These layers consist of small patches 101 arranged in an 8×8 grid formation, symmetrically and interlaced around the central axis of the element (FIG. 2A, 2B). The small patches 101 possess dimensions of 0.415 mm in side length, with a center-to-center spacing of 0.21 mm. The metasurface functions as a wide-angle impedance matching layer 1 and impedance transformer, facilitating the transition from the antenna radiator to the surrounding air. The strong coupling between these patches 101 and their interlaced configuration effectively transforms the antenna's equivalent impedance, leading to enhanced operating bandwidth and improved scanning capabilities in two-dimensional planes.

Beneath these metasurface layers, seven additional conductive layers (L03-L09) and conductive vias are configured to form a cylindrical dielectric resonating cavity 2 (FIG. 3A, 3B). This cavity 2 is enclosed and shielded by metallic via walls 102 and layers 103. At the base of the cavity 2, a conductive ground plane 104 (L10) with a cross-shaped slot 105 etched into it facilitates excitation. The diameter of the cylindrical cavity 2 is 3.4 mm, and the cross slots 105 have dimensions of (1.73, 0.17 mm) and (1.58, 0.126 mm) for length and width, respectively.

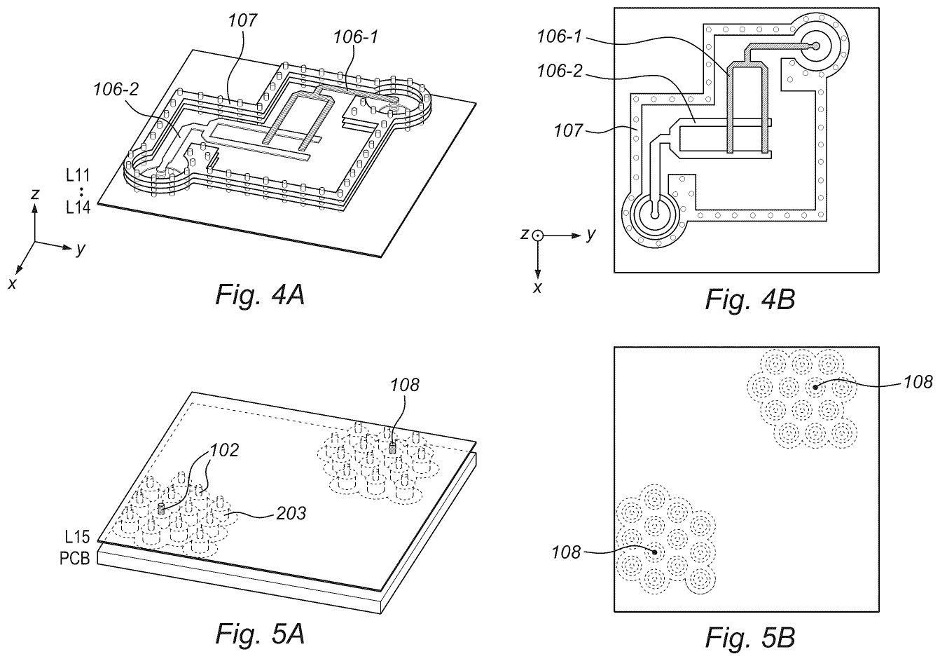

Positioned below the ground plane (L10) are two orthogonal conductive forks 3, each situated within a separate layer (FIG. 4A, 4B). These forks 3 serve the purpose of feeding the cross-shaped slot 105 and are interconnected to conductive vias 103, which traverse through the coaxial aperture 108 in the lower ground plane (L15). These conductive forks 3 are enclosed by radio frequency (RF) shield walls 107 constructed from conductive layers and vias (L11-L14). By selectively exciting one of the forks 106-1 or 106-2 through the coaxial apertures 108, the resulting electromagnetic field is directed according to the orientation of the respective fork 106-1 or 106-2. This enables excitation of the cross-shaped slot 105 in one polarization, followed by its transmission through the dielectric resonator and metasurface. This mechanism holds true for both orthogonal linear polarizations. The dimensions of the forks 106-1, 106-2 are (1.61, 0.11 mm) and (1.75, 0.17 mm) for length and width, respectively.

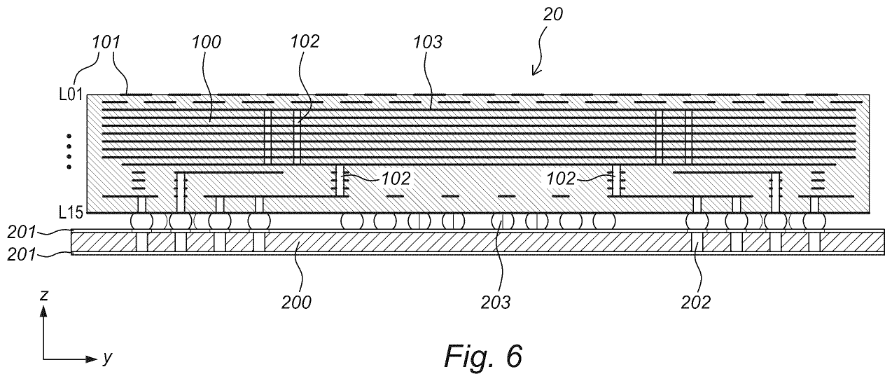

The LTCC antenna is affixed via L15, the lower ground plane, to a printed circuit board ‘PCB’ 4, 200 using ball grid arrays, ‘BGAs,’ 203 for electrical connection (FIG. 5A, 5B). The BGA 203 comprises an array of soldering balls that are aligned and soldered between the two laminates, ensuring the electrical conduction of ground planes and signals between the laminates. The PCB 200 is commonly employed as a fundamental circuit laminate to consolidate all signals from antenna elements along with their associated feeding networks. The antenna module incorporates two orthogonal feeds, resulting in two distinct linear polarizations: H (horizontal) and V (vertical). The V-polarization aligns with the x-axis, while the H-polarization aligns with the y-axis as indicated in, e.g., FIG. 1 and FIG. 6. The BGA 203 arrangement consists of isosceles triangular lattices with a pitch of 0.55 mm, and the solder ball diameter measures 0.3 mm.

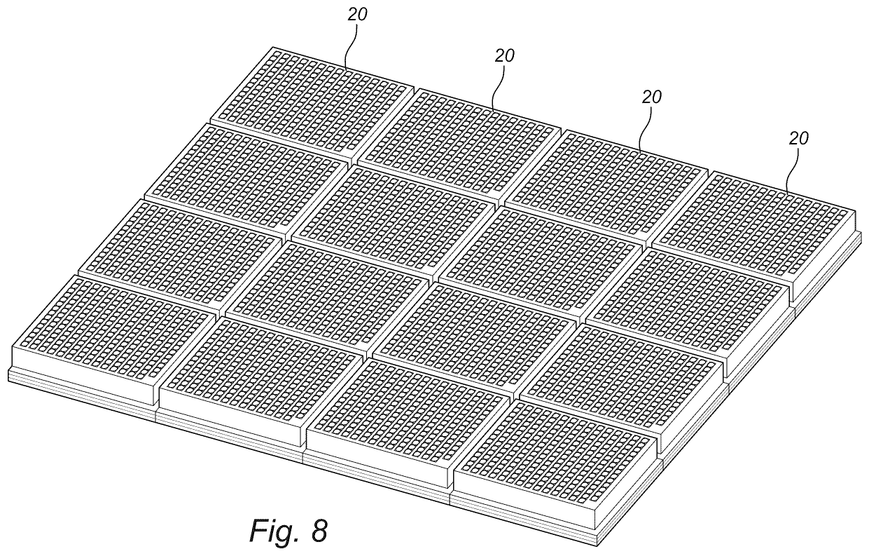

For the construction of a large array configuration, the antenna elements of FIG. 1 are organized in the form of a 2×2 subarray 20 (FIG. 6). These antenna elements are mirror-symmetrically duplicated within the subarray. The subarray is situated on a PCB 200 laminate of similar dimensions and is interconnected via BGAs 203. This configuration of the subarray on the PCB 200 is referred to as the subarray module, which facilitates duplication for the formation of large arrays. The advantages of this subarray module include the integration of radio frequency integrated circuits (RFICs) within the structure and the ability to address issues related to heat dissipation, substrate warpage, complex RFIC routing, and chip integration, which can be encountered in large multilayer laminates. The subarray module itself has dimensions of 10 mm×10 mm×2.57 mm. Such subarrays may be combined into larger arrays, e.g. 4×4 square arrays (FIG. 8).

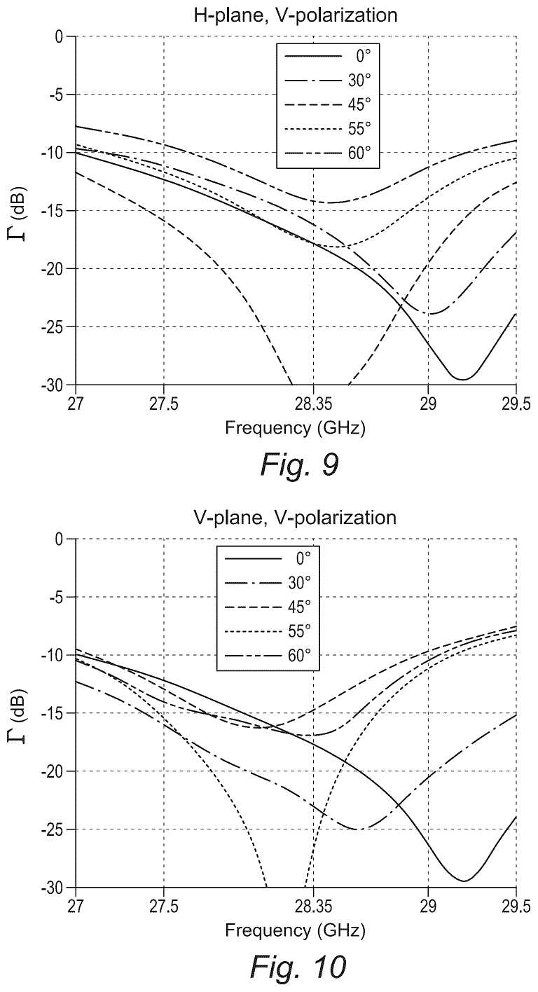

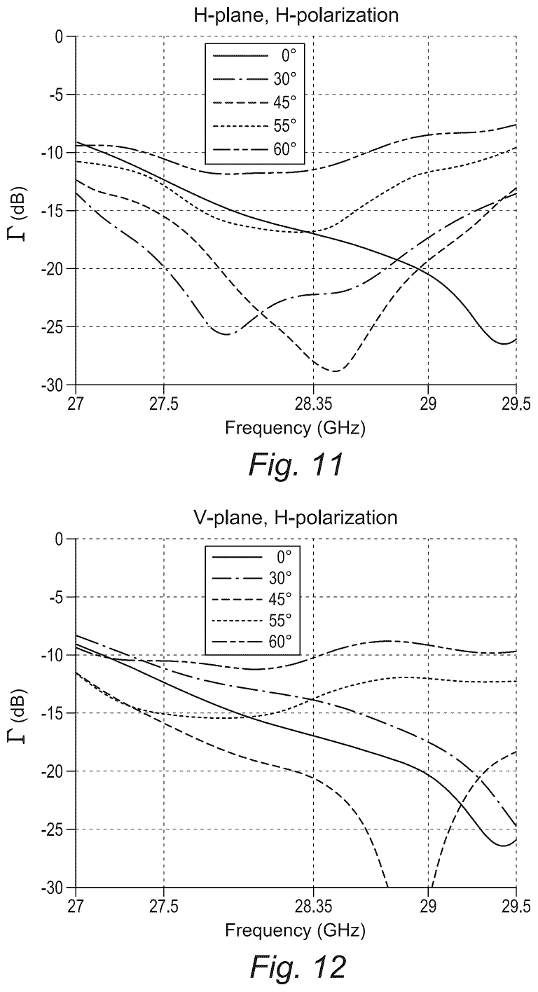

The advantages of the present invention are shown in FIGS. 9 to 16. The full array topology is validated by arranging the 2×2 sub-array modules 20 in a total 4×4 square lattice. The frequency behavior of the simulated active reflection coefficient (|Γ|) across the 27.5-29 GHz band, shows that |Γ|≤−10 dB is achieved for most of the scan angles within ±60° and for both polarizations in both orthogonal planes (horizonal and vertical), as displayed in FIGS. 9 and 10 (V-polarization) and FIG. 11 and FIG. 12 (H-polarization).

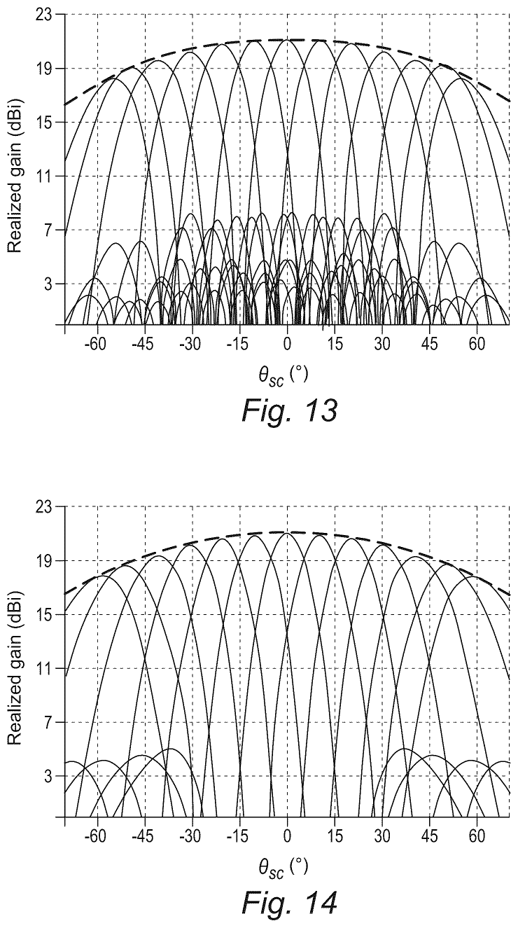

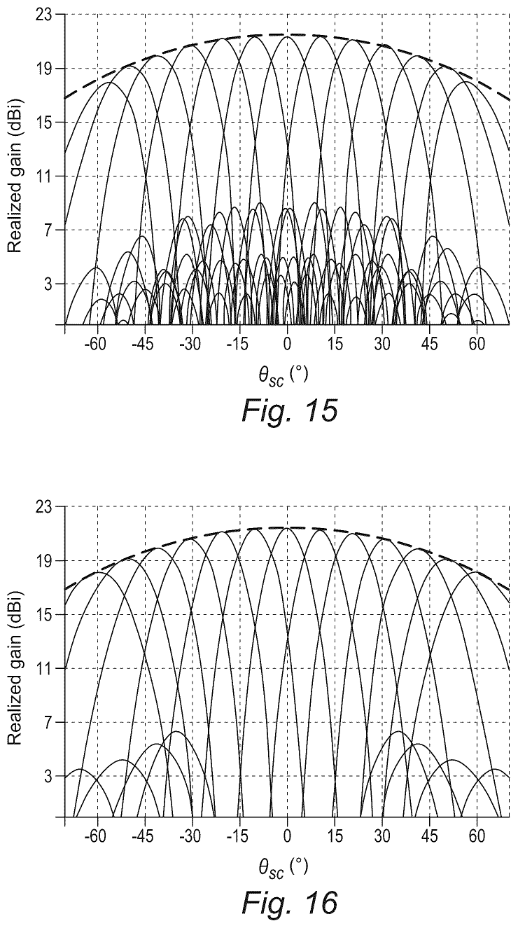

FIG. 13-16 display the scanning performance in H/V planes at 27 (FIGS. 13, 14) and 28.35 GHz (FIG. 15, 16) respectively. The results show the beam-steered radiation patterns and scanning performances, with co-polarized realized gain distributions of the full array with uniform amplitude excitation and corresponding linear phase progression. The proposed array architecture is thus characterized by a wide-angle planar scanning capability.

In the preferred embodiment the number of layers equal to 15, wherein the operating frequency is the 27-29 GHz band. The proposed architecture of the elements and arrays can easily be tailored towards various other applications or frequency ranges. LTCC provides for a versatile method in this sense. It will be clear that the invention is not limited to the exemplary embodiments which are illustrated and described here, but that countless variants are possible within the framework of this invention, which will be obvious to the person skilled in the art. In this case, it is conceivable for different inventive concepts and/or technical measures of the above-described variant embodiments to be completely or partly combined without departing from the inventive idea described in this invention.

FIG. 1: The antenna element detailed view. A transparent view of the antenna element from the side. The various layers are shown in FIG. 2A, 3A, 4A, 5A (side views) and in FIG. 2B, 3B, 4B, 5B (top views). L01-L02 are two layers with small patches 101, serving as a metasurface structure. L03-L019 constitute seven additional conductive layers 103 and conductive vias 102 configured to form a cylindrical dielectric resonating cavity 2. This cavity 2 is enclosed and shielded by metallic via walls and layers. At the base of the cavity 2, a conductive ground plane 104 (L10) with a cross-shaped slot 105 etched into it facilitates excitation. L11-L14 provide for two different feed forks 106-1, 106-2 (in different layers), shielded by a metal RF shield wall 107.

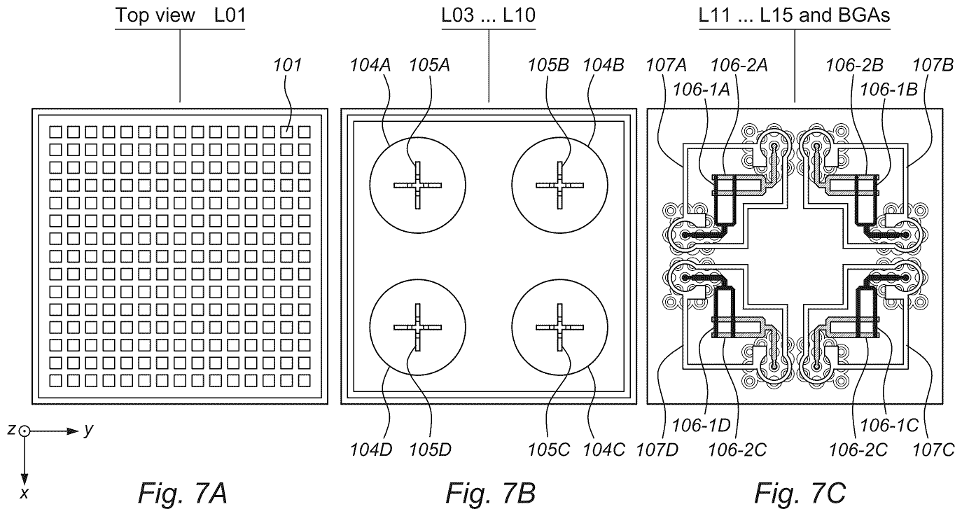

FIG. 6: The antenna subarray detailed view. A cross section of the 2*2 element array, consisting of four antenna elements from FIG. 1 with L01-L015. Below the element the PCB 200 is shown with metallic vias 202, and with copper layers 201 on both sides, and BGA connection 203. FIG. 7A: A detailed top view of the first two layers L01-L02, including patches 101. FIG. 7B: the resonant cavities 2A, 2B, 2C, 2D with crossed slots 105A, 105B, 105C, 105D at the bottom (L03-L10). FIG. 7C The L11-L15 layers, including four pairs of conductive forks 106-1A, 106-2A; 106-1B, 106-2B; 106-1C, 106-2C; 106-1D, 106-2D and the shield walls 107A, 107B, 107C, 107D surrounding them, with BGA's shown.

FIG. 8: The large array formed with multiple subarray 2*2 modules of FIG. 6 in case of 4*4 rectangular lattice.

FIG. 9-10: The frequency behavior of the simulated active reflection coefficient (|Γ|) across the 27.5-29 GHz band for the 4*4 antenna module array results: active reflection coefficients when scanning in H-/V-plane for V-polarization ports (0°, 30°, 45°, 55° and 60°).

FIG. 11-12: The frequency behavior of the simulated active reflection coefficient (|Γ|) across the 27.5-29 GHz band for the 4*4 antenna module array results: active reflection coefficients when scanning in H-/V-plane for H-polarization ports (0°, 30°, 45°, 55° and 60°).

FIG. 13-14: The beam-steered radiation patterns and scanning performances for the H-polarization along the H-/V-planes for H-polarization at 27.5 GHz. The results show the co-polarized realized gain distributions of the full array with uniform amplitude excitation and corresponding linear phase progression. The proposed array architecture is characterized by a wide-angle planar scanning capability with scan losses following the 10 log(cos(θsc)) profile in the ±55°/±60° range along the H-/V-planes. The performance is highly symmetrical for the other orthogonal polarization. The black dashed lines show cos(scan angles) in dB profile.

FIG. 15-16: The beam-steered radiation patterns and scanning performances in H-/V-planes for H-polarization at 28.35 GHz. The black dashed lines show cos (scan angles) in dB profile. The results show the co-polarized realized gain distributions of the full array with uniform amplitude excitation and corresponding linear phase progression. The proposed array architecture is characterized by a wide-angle planar scanning capability with scan losses following the 10 log(cos(θsc)) profile in the ±55./±60° range along the H-/V-planes. The performance is highly symmetrical for the other orthogonal polarization. The black dashed lines show cos (scan angles) in dB profile.

1. An antenna element, comprising:
a dielectric substrate,
a multi-layer laminate structure included in the dielectric substrate,
wherein the multi-layer laminate structure comprises:
an impedance matching layer;
at least one resonating cavity with a cross-shaped slot;
at least one pair conductive forks, configured and arranged to feed the at least one cross-shaped slot.

2. The antenna element of claim 1, wherein the resonating cavity is formed below the impedance matching layer.

3. The antenna element of claim 1, wherein the two conductive forks are arranged below the resonating cavity, preferably underneath the cross-shaped slot.

4. The antenna element of claim 1, wherein a vertical separation between the layers of the multi-layer laminate structure is fixed, preferably at about 0.1 mm.

5. The antenna element of claim 1, wherein the impedance matching layer comprises a metasurface layer, formed by two or more conductive sublayers,
wherein each of the two or more conductive sublayers comprises patches arranged in a grid formation.

6. The antenna surface of claim 5, wherein the patches of the two or more conductive sublayers are interlaced.

7. The antenna surface of claim 5, wherein, in each of the conductive sublayers, the patches are arranged symmetrically around a central axis of the antenna element.

8. The antenna element of claim 1, wherein the resonating cavity is cylindrical.

9. The antenna element of claim 1, wherein the resonating cavity is enclosed and shielded by conductive via walls and layers.

10. The antenna element of claim 1, wherein at least one conductive ground plane is provided at the base of the resonating cavity and wherein the cross-shaped slot is provided, preferably etched, in said at least one conductive ground plane.

11. The antenna element of claim 1, wherein the conductive forks of the pair of conductive forks are arranged orthogonally.

12. The antenna element of claim 1, wherein each of the conductive forks of the pair of conductive forks is arranged in a separate layer.

13. The antenna element of claim 1, wherein the pair of conductive forks is enclosed by RF-shield walls, preferably constructed from further conductive layers and vias.

14. The antenna element of claim 1, wherein the multi-layer laminate structure further comprises a lower ground plane, arranged below the pair of conductive forks, and wherein the pair of conductive forks is interconnected to conductive vias, which traverse through coaxial apertures in the lower ground plane.

15. The antenna element of claim 1, wherein the antenna element is configured to operate at an operating frequency between about 27 GHz and about 29 GHz, preferably about 28 GHz, and/or has a side length of 0.47 times the wavelength in free space.

16. The antenna element of claim 1, wherein the dielectric substrate is a ceramic substrate, preferably fabricated utilizing low temperature co-fired ceramic technology, LTCC.

17. An antenna subarray comprising:
a dielectric substrate,
a multi-layer laminate structure included in the dielectric substrate,
wherein the multi-layer laminate structure comprises:
an impedance matching layer;
an array of resonating cavities, each with a cross-shaped slot;
an array of pairs of conductive forks, each pair of conductive forks being configured and arranged to feed the cross-shaped slot of a corresponding resonating cavity.

18. The subarray of claim 17, wherein the array of pairs of conductive forks is a 2×2 array, which is preferably mirror-symmetric and/or point symmetric.

19. An antenna system for wide-angle scanning comprising a printed circuit board, and, affixed to the printed circuit board via a ball grid array, at least one antenna element according to claim 1 and/or at least one subarray module according to claim 17.

20. The antenna system according to claim 19, comprising a 4 by 4 array of subarray modules according to claim 17.
